(19) United States
(12) Patent Application Publication
(10) Pub. No.: US 2025/0146893 A1
(43) Pub. Date: May 8, 2025

(54) TRANSISTOR CHANNEL STRESS AND MOBILITY METROLOGY USING MULTIPASS SPECTROSCOPIC ELLIPSOMETRY AND RAMAN JOINT MEASUREMENT

(71) Applicant: KLA CORPORATION, Milpitas, CA (US)

(72) Inventors: Houssam Chouaib, Milpitas, CA (US); Zhengquan Tan, Cupertino, CA (US); Shova Subedi, San Jose, CA (US); Shankar Krishnan, Cupertino, CA (US); David Y. Wang, Santa Clara, CA (US); Oleg Shulepov, San Jose, CA (US); Kevin Peterlinz, Fremont, CA (US); Natalia Malkova, Milpitas, CA (US); Dawei Hu, Milpitas, CA (US); Carlos Ygartua, San Jose, CA (US); Isvar Cordova, Sunnyvale, CA (US); Eric Cheek, Westland, MI (US); Roman Sappey, San Jose, CA (US); Anderson Chou, Hillsboro, OR (US)

(21) Appl. No.: 18/936,993

(22) Filed: Nov. 4, 2024

Related U.S. Application Data
(60) Provisional application No. 63/547,849, filed on Nov. 8, 2023.

(51) Int. Cl. G01L 1/24; G01B 11/06; G01B 11/24

(52) U.S. Cl. CPC G01L 1/24; G01B 11/06; G01B 11/24

(57) ABSTRACT

A workpiece is measured using multiple-pass spectroscopic ellipsometry and multi-wavelength Raman spectroscopy, which may be performed in the same system. These measurements are combined to form combined measured data. A stress measurement of the workpiece is determined using the combined measured data. The stress measurement can be determined using a model or a machine learning algorithm.

### CROSS-REFERENCE TO RELATED APPLICATIONS

This application claims priority to the provisional patent application filed Nov. 8, 2023 and assigned U.S. App. No. 63/547,849, the disclosure of which is hereby incorporated by reference.

### FIELD OF THE DISCLOSURE

This disclosure relates to measuring a film stack on a workpiece, such as a semiconductor wafer.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on workpieces to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Metrology processes also are used at various steps during semiconductor manufacturing to monitor and control the process. Metrology processes are different than inspection processes in that, unlike inspection processes in which defects are detected on workpieces, metrology processes are used to measure one or more characteristics of the workpieces that cannot be determined using existing inspection tools. Metrology processes can be used to measure one or more characteristics of workpieces such that the performance of a process can be determined from the one or more characteristics. For example, metrology processes can measure a dimension (e.g., line width, thickness, etc.) of features formed on the workpieces during the process. In addition, if the one or more characteristics of the workpieces are unacceptable (e.g., out of a predetermined range for the characteristic(s)), the measurements of the one or more characteristics of the workpieces may be used to alter one or more parameters of the process such that additional workpieces manufactured by the process have acceptable characteristic(s).

In-line optical metrology techniques can include spectroscopic ellipsometry (SE) and spectroscopic reflectometry (SR). SE is an optical measurement technique that measures the change in polarization of the outgoing light reflected from the sample, such as a workpiece. SE can measure parameters like thickness, optical constants like refractive index and extinction coefficients (n and k), material properties like crystallinity, surface roughness, alloy composition, anisotropy, or other parameters. SE can be robust technique to measure critical parameters for the thin film or multiple film stacks, but SE is less sensitive when measuring strain.

Raman scattering is based on the inelastic scattering of the incident light by optical phonon or molecular vibration of the sample, such as a workpiece. It measures the change in frequency of the outgoing light relative to the incoming or impinging light frequency that is caused by scattering. It can quantify the material properties like material species, its chemical nature, crystallinity, stress/strain, concentration, or other parameters. Raman peak positions and full-width-at-half-maximum (FWHM) of the Raman peaks can be used to estimate the concentration and thicknesses. Also, change or shift in Raman scattered energy can reveals stress/strain of the sample. Raman measurements of channel stress can be made on a processed structure during gate-all-around (GAA) device fabrication by detecting the Raman shift (in wavelength) in Si—Si bonding that is sensitive to stress. Unfortunately, this cannot be divided to an individual transistor stress level and channel stressed volume.

Manufacturers are reaching physical limits when shrinking transistors, so manufacturers are adding SiGe alloys, SiC, GaN, or other material to increase the strain of the Si channels, which improves and allows selective control of the mobility of the carriers. Continued scaling and performance enhancement through introduction of new materials and structures will increase complexity. Non-destructive in-line monitoring techniques that are fast and can monitor a sub-micrometer spot size are needed. A probing volume depends on the spot size and penetration depth, which in turn depends on the wavelength of the laser. This can be performed using high-resolution multiwavelength (MWL) Raman.

Transistor performance will be improved by reducing the dimensions, using new device structures like a gate-all-around FET (GAA FET) or complementary FET (CFET), and performing electrostatic control using stress of the channels. The current technique to monitor GAA FET devices or a film is based on multi-angle broad band SE in combination with reflectometry. SE can be useful in characterizing the composition of single layer or multilayer structure with high material contrast. The measured spectra are fitted to a theoretical optical model in the broadband wavelength range where film parameters like n, k, and thickness of a single layer or complex multilayer stacks can be determined. This fitting can be complicated for multilayer film stacks and may be unable to characterize the defect, strain, and interfacial diffusion. The previous technique is limited when measuring a multilayer stack with small material contrast and graded layer. Such a situation can require an accurate model to describe the layers. The deeper layer may have higher uncertainty when measuring the film parameters.

Raman or single-pass SEs tend to lack sufficient signals and sensitivity to determine strain, composition, and thickness in one measurement apparatus or for individual layers. For example, Raman cannot separate individual transistor-level stress and the stressed channel volume for GAA devices. Single-pass SE and SR cannot separate feature critical dimension, size, volume or stress at the individual transistor level for GAA devices. Single-pass SE and SR also have limited sensitivity for superlattice composition, strain, and thickness measurement. The correlation between composition/strain and thickness measurement means that individual layer thickness and composition may be limited to three pairs. This may not meet requirements for four pairs or higher, which means single pass SE and SR may not be suitable for a double superlattice with middle defect insulator (MDI).

Single pass optical spectroscopic ellipsometry (SPSE) with SR has been suggested for measurements of the GAA device during fabrication for critical dimension, shape, and stress modeling. However, it is still challenging to separate critical dimension, feature sizes, and stress at an individual transistor level using SPSE with SR.

X-ray based technologies, like X-ray diffraction (XRD), X-ray reflectivity (XRR), X-ray fluorescence (XRF), or their combination can provide improved measurements, but have throughputs that are too low for a practical measurement in a manufacturing setting. XRR is good for individual thicknesses and has some sensitivity to Ge % via material density change with Ge %, but it is not sensitive to strain, cannot determine relaxation and partial strained processes, and is not precise enough for composition. XRF can detect composition, but is limited to a single layer or one average value for a superlattice. XRF cannot provide for individual layer composition or thickness and does not have sensitivity to strain. High-resolution XRD measurements of a stressed channel lattice constant can determine channel stress on a structured GAA device. High-resolution XRD can provide good strain and inferred composition for planar SiGe/Si and superlattice (before patterning to make a GAA device) and potentially a two-stack superlattice with an MDI. The individual thickness is less precise or accurate than some process control standards. XRD also cannot meet manufacturer throughput requirements. XRD measurements for individual layer strain and composition can take more than ten minutes to complete.

Transmission Electron Microscopy (TEM) is often used to measure the thickness for individual layers. However, TEM is destructive, time-consuming, and not sensitive to composition. Its use is generally limited to troubleshooting. High-resolution TEM (HRTEM) suffers from limitations due to specimen preparation, field of view, and noise. Mapping strain across multilayers and transistor arrays requires fields of view that are not easily accessible with HRTEM. HRTEM also can induce strain-relaxation effects.

Nano beam electron diffraction (NBED) does not require a reference and can be sheet specific for a GAA device. However, it may work best for thin layers with a large amount of data generated for processing. NBED also is destructive and time-consuming. A measurement may take one hour or more to complete.

Therefore, new techniques and systems are needed.

### BRIEF SUMMARY OF THE DISCLOSURE

A method is provided in a first embodiment. The method includes measuring a workpiece using multiple-pass spectroscopic ellipsometry (MPSE) thereby generating first optical measurements. The workpiece is measured using multi-wavelength Raman spectroscopy thereby generating second optical measurements. Using a processor, the first optical measurements and the second optical measurements are combined to form combined measured data. Using the processor, a stress measurement of the workpiece is determined using the combined measured data.

The method may include determining, using the processor, a critical dimension of the workpiece using the combined measured data, a shape of a feature on the workpiece using the combined measured data, and electrical parametric performance of a device on the workpiece using the stress measurement, the critical dimension, and the shape of the feature.

The determining may use a model and/or a machine learning algorithm.

The stress measurement may include a stressed volume and directional components.

The method may include determining a thickness, a strain, or a composition of the workpiece.

The stress measurement may be of a transistor channel on the workpiece.

A system is provided in a second embodiment. The system includes a multiple-pass spectroscopic ellipsometry (MPSE) unit to measure a workpiece and generate first optical measurements; a multi-wavelength Raman spectroscopy unit to measure the workpiece and generate second optical measurements; and a processor in electronic communication with the MPSE unit and the multi-wavelength Raman spectroscopy unit. The processor is configured to combine the first optical measurements and the second optical measurements to form combined measured data and determine a stress measurement of the workpiece using the combined measured data.

The processor may be configured to determine a critical dimension of the workpiece using the combined measured data, a shape of a feature on the workpiece using the combined measured data, and electrical parametric performance of a device on the workpiece using the stress measurement, the critical dimension, and the shape of the feature.

The stress measurement may be determined using a model and/or a machine learning algorithm.

The stress measurement may include a stressed volume and directional components.

The processor may be configured to determine a thickness, a strain, and a composition of the workpiece.

A non-transitory computer-readable storage medium is provided in a third embodiment. The non-transitory computer-readable storage medium can include one or more programs for executing the following steps on one or more computing devices. First optical measurements of a workpiece measured using multiple-pass spectroscopic ellipsometry (MPSE) and second optical measurements of the workpiece using multi-wavelength Raman spectroscopy can be received. The first optical measurements and the second optical measurements can be combined to form combined measured data. A stress measurement of the workpiece can be determined using the combined measured data.

The stress measurement may be determined using a model and/or a machine learning algorithm.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram showing an exemplary layout of Raman spectroscopy;

FIG. 2 illustrates exemplary laser excitation at different wavelengths probing up to different film stacks;

FIG. 3 illustrates corresponding spectra forms for FIG. 2;

FIG. 4 is a diagram showing an exemplary layout of spectroscopic ellipsometry;

FIG. 5 is a flow chart of a method in accordance with the present disclosure; and

FIG. 6 is a system that includes both a multiple-pass spectroscopic ellipsometry unit and a multi-wavelength Raman spectroscopy unit.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein provide accurate, robust, and practical metrology for transistor level channel stress and mobility for process monitor and control in semiconductor devices, such as gate-all-around (GAA) type logic devices. Embodiments disclosed herein also provide a cost-effective metrology for strain, composition, and thickness of materials and structures used for semiconductor processes, such as SiGe/Si and SiC/Si, SiCP/Si layers, or SiGe/Si superlattice, in logic device transistor mobility engineering. In a GAA device, three or more transistors are stacked up vertically in a single process flow. Each transistor has its own electrical, or parametric performance in driving current, threshold voltage, and leakage current. The required driving current is achieved through engineering of the gate width, gate length, and the channel stress to increase mobility using multiple process steps. Monitoring and controlling the process conditions during the manufacturing process can affect the final channel stress and transistor driving current. A multiple-pass spectroscopic ellipsometry (MPSE) and multi-wavelength Raman spectroscopy with joint analyses of these measurement signals can be used to determine the individual transistor level channel stress for the GAA device or other semiconductor devices.

Principal components (PCs) of the resulting signals can be used to determine the final transistor mobility and driving current (ID) using the wafer-acceptance-test (WAT) electrical data and MPSE and multi-wavelength Raman spectroscopy (MWRM) signals. This can monitor PCs and ID in run-time measurements. This can enable selection of process steps in the channel-mobility-engineering flow to monitor and control the final channel stress, such as for liner and stress layer deposition, source/drain etch, n-EPI and P-EPI, nanosheet release, or metal gate. Channel stress can be the accumulation of these process steps. MPSE and MWRM may be optimized for each of these process steps.

Each technique can separately measure some or all the film properties (e.g., composition, strain, thickness), but multiple techniques can complement each other in combination and can improve the accuracy and precision of the measured components. In addition, by training machine learning (ML) models using measured spectra through deep learning, a neural network analysis can help to measure film parameters efficiently.

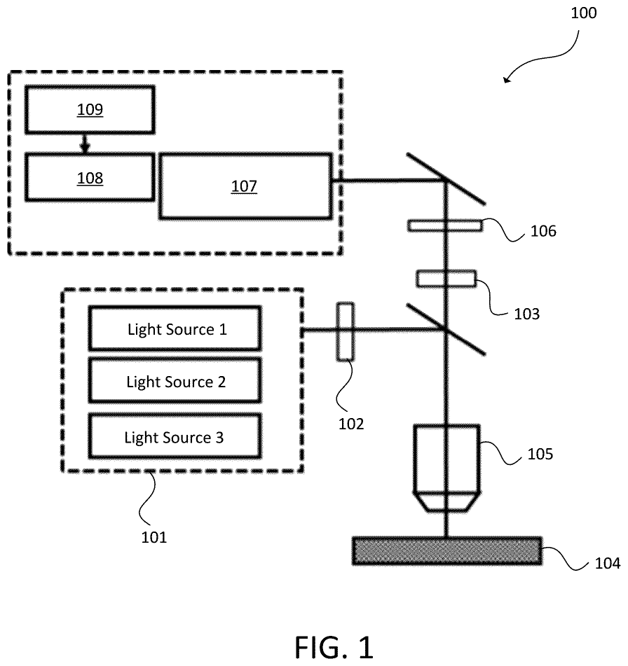

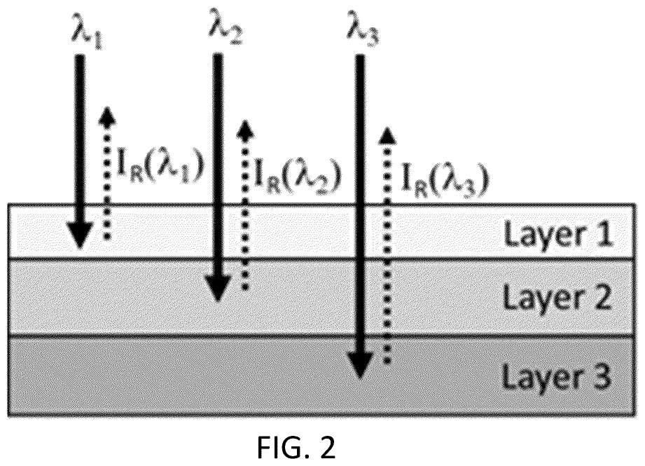

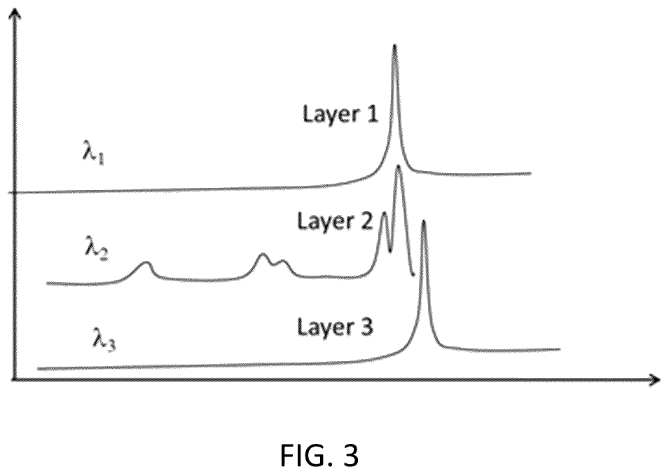

Raman spectroscopy is sensitive to the composition and stress of the Raman active material. FIG. 1 is a typical layout for a Raman spectroscopy system 100 that includes multiple laser excitation sources (in the light source 101), a polarization assembly 102, an analyzer rotation assembly 103, and objective 105, and a laser line filter 106. The Raman spectroscopy system 100 can operate at MWRM. The stress or strain of the sample 104 (e.g., the workpiece, which can be a semiconductor wafer) can change the well-defined Raman band, lift the degeneracy, and shift the band position. This can change the band shape and distort the symmetry of the band. A spectrometer 107 and detector 108 is used with a controller 109 (which can include a processor) to determine measurements. A material on or in the sample 104 (e.g., a workpiece) has a different absorption coefficient at different wavelengths and can interact up to certain depth in the absorbing medium. The shorter wavelength can probe shallow layers while changing to longer wavelength can enable selective probing of certain layers, which is depicted in the FIG. 2. This can result in different Raman profiles for different wavelengths, as shown in FIG. 3. A Raman signal from each excitation comes from the interacted volume in the film layers and its profile has the characteristic feature of those layers. Depending on the wavelength of excitation, the Raman signal IR (1) has a different peak position and profile, which can provide the composition (x) and strain (E) of the layer. Also, IR (1) can be a function of material properties like refractive index (n), extinction coefficient (k), thickness, strain, or other parameters and the response can be different for different wavelength excitations.

Similarly, SE and SR spectra may depend on the dispersion of the material over the wavelength range. Broadband spectroscopic ellipsometry (BBSE) can cover single angle of incidence (AOI), such as 65 degrees, or multiple AOIs ranging from 0 to 90 degrees. Ellipsometry covers all the types of ellipsometry such as rotating analyzer/polarizer ellipsometry, rotating compensator and compensators, or a combination of rotating analyzer/polarizer/compensators. The BBSE signal includes, but is not limited to, tanΨ, cosΔ, harmonics, Mueller matrix, or Stokes vectors. Based on the reference t and x %, the SE and SR model can be optimized and tested so that the model fits the measured spectra with the value of reference thickness and composition.

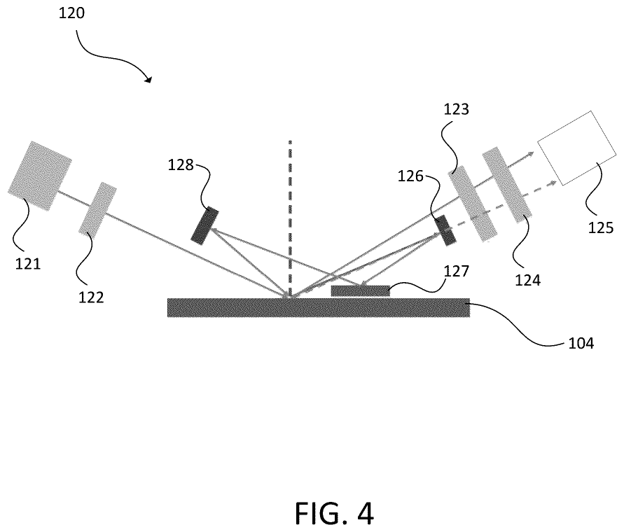

FIG. 4 is a typical layout for MPSE. The MPSE system 120 includes a light source 121 that directs a beam through a component 122 at the sample 104, which can be a primary target. The component 122 may be a rotating polarizer or rotating compensator. Some light reflected from the sample 104 is received by the rotating compensator 123, analyzer 124, and then the SE spectrometer 125. Some light reflected from the sample 104 is reflected by a reflector 126 and is directed at a modulating target 127. This light is then reflected by reflector 128 before being again reflected from the sample 104 and received by the rotating compensator 123, analyzer 124, and then the SE spectrometer 125. The distribution of light across the optical spectrum can be measured to show the interaction between the light and the sample 104. MPSE can provide a two-pass operation to enhance measurement target sensitivity by adding the modulating target 127 to the primary target (i.e., sample 104) in the SE path. In an embodiment, the modulating target 127 can be removed and the measurement target 104 can be placed at the lateral location of the modulating target 127 to allow the measurement target 104 to be measured three times by SE. This includes two times at the primary location and one time at the modulating target 127, which can be about 2-5 mm from the primary target. The MPSE also may include configuring the reflector 126 and reflector 128, a beam splitter or diffraction grating at the laser line filter 106, and/or a curved mirror with a pin-hole at the reflector 128 in a manner that the SE beam measures the primary target on the sample 104 three times.

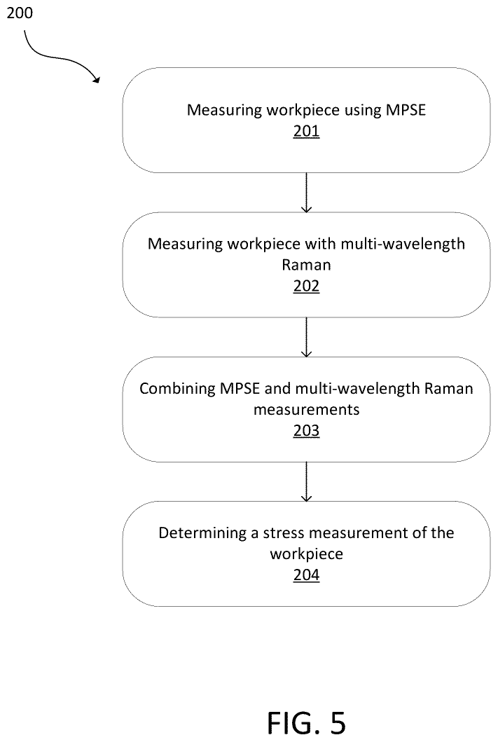

FIG. 5 shows an embodiment of the method 200. Some of the steps can be performed using a processor.

At 201, a workpiece is measured with MPSE, which generates first optical measurements. An embodiment of MPSE is shown in FIG. 4. Multiple passes are used to provide improved sensitivity to the structure features such as critical dimension, shape, feature size, volume, and/or stress in a channel. This information can be provided for an individual transistor and to the individual layer thickness and strain/composition. This enhanced sensitivity also can reduce the correlation between thickness and composition/strain.

At 202, the workpiece is measured with MWRM, which generates second optical measurements. An embodiment of MWRM is shown in FIG. 1. MWRM can sample a subset or full set of transistors in a structure on the workpiece for channel stress. MWRM can selectively probe top-most (e.g., 1-2) or all layers in the superlattice or multi-transistor superlattice. This provides better individual layer strain/composition sensitivity.

In steps 201 and 202, the measurement and sampling plan can be created for the device manufacturing process, device structure, and manufacturer needs for the MPSE and MWRM operations (e.g., throughput). MWRM and MPSE can be performed on the same material and/or the same sample.

Steps 201 and 202 can be performed simultaneously, partially-simultaneously, or sequentially. Embodiments disclosed herein are non-destructive and can monitor in-line semiconductor processes. In an instance, each measurement can take from 1-5 seconds. Steps 201 and 202 can be performed in a single tool. For the simultaneous measurements, MPSE can add additional sensitivity to MWRM signal.

The first optical measurements and the second optical measurements are combined at 203 to form combined measurement data. Modeling and analyzing the combined measurement data can enable quantitative and accurate determination of the channel stress for the individual transistors in the GAA device.

Forming the combined measurement data can include processing the MWRM and MPSE data. This can use a common physical model for the target, which can include the shape, CD, thickness, composition, and/or stress to regress the combined MWRA and MPSE signals with system models verified on simpler target, and validated on combined measurements. A proven model-based machine learning (ML) can further refine the metrology performance.

A stress measurement is determined at 204 using the combined measurement data. Thus, both the first optical measurements and second optical measurements are used to determine the stress measurement. Determining the stress measurement can use a model or a machine learning algorithm. In an example, the stress measurement is of a transistor channel on the workpiece. However, other device features or workpiece locations can be measured.

The physical model usually can be built with the expected shape and nominal CD, thickness, or index of refraction (n and k) for the material properties. n and k also can be connected with the composition in case of SiGe and stress or with stress in case of pure-single element materials, like Si, or Ge. The shape the structure can be determined by the arranged material relative position and their sizes (dimensions). The response of MWRM and MPSE signals can be constructed from what system models for the MWRA and MPSE measurement apparatus that was built, tested, and calibrated. The model parameters (dimension of interest (DOIs) including CD, thickness, composition, stress, and n and k) can then be determined by matching a theoretical search in DOI until the computed signals match the measured signals within predetermined criteria.

The stress measurement can be determined with the common physical model including stress and composition using the MWRM and MPSE signals, in which the shape like CD, thickness, and stress may be solved simultaneously. The model-based ML can then selectively measure stress, CD, and other properties of interest on the workpiece target measured.

In an embodiment, an analytical model for the structure and stress is made to quantitatively fit and/or regress the combined measurement data.

In another embodiment, a construction of a physical model for first-principle based analyses can be used with machine learning analyses to further enhance the robustness of thickness and strain/composition measurement, allowing metrology to cover wider process changes.

The stress measurement can include a stressed volume and directional components of the stress. For example, channel stress and its derived properties (e.g., stress multiplied by the stressed volume) and/or stress directional components can be reported for further insights into the channel/electrical behavior.

Stressed volume and the stress directional components can be simultaneously determined by MWRM acquired with the workpiece target rotating to a few (e.g., 2-4) azimuth angles. Targets on a wafer and wafer rotation may be rotated to pre-selected orientation, called azimuth angles. The MWRA signals may be proportional to the stressed volume, and directional stress components can be projected to the measurement Raman laser polarization direction. The same volume may also be measured optically to determine CD (MPSE) because volume times the n and k is tied to stress and composition. The combined MWRM and MPSE can enable further separation of volume (CD and shape) and the stress components that may not be achieved by Raman or SE as separate measurements.

In an instance, a critical dimension (e.g., gate width or gate length), shape, and/or volume of a feature on the workpiece also can be determined using the combined measurement data by analytical regression and a library or machine learning. Specifically, the method to process the MWRM and MPSE embodiments include, but are not limited to, the use of a common physical model for the target consisting the shape, CD, thickness, composition, and stress to regress the combined MWRA and MPSE signals with system models verified on simpler target, and validated on combined measurements. Machine learning can be added to refine the metrology performance.

Electrical parameter performance of a device on the workpiece can be determined using the stress measurement, critical dimension, and shape of the feature. The electrical performance, such as the transistor driving current, threshold voltage, or leakage current, can be determined in the final transistor shape, CD, thickness, channel stress, high-k bandgap, and work function materials type, amount, and processes to produce the transistor. One specific performance, like the driving current and mobility, can be determined primarily by the channel stress, the intrinsic channel material mobility, and doping levels. In addition, the channel stress can be accumulated from several channel stress engineering process steps plus the side effects of other process steps, like nanowire release in GAA and metals depositions. Monitoring the channel stress and their evolution or accumulation in the process flow can provide a desired final driving current in process integration development and in production. This need is further highlighted by the complexity of GAA and future CFET devices in which multiple transistors are placed next to each other (e.g., 3 or 4 in GAA, likely more in CFET) in the device with each needing to achieve their optimized electrical performance target. Inversely, the measured final driving current on the manufactured transistor and its relation to each process step in the flow can be determined if channel stress are measured at the individual stress-impacting process steps. Embodiments disclosed herein can enable faster optimization in development (i.e., fewer development cycles) and stable production for driving current, mobility, and the operational function of the device.

In an instance, a thickness, a strain, index of refraction, and/or a composition of the workpiece also can be determined from the first optical measurements and/or second optical measurements.

In an example, gate width, gate length, and mobility can be determined, which can provide a transistor driving current. These measurements can be made simultaneously.

Measurements made herein can be made on design-rule targets or actual devices.

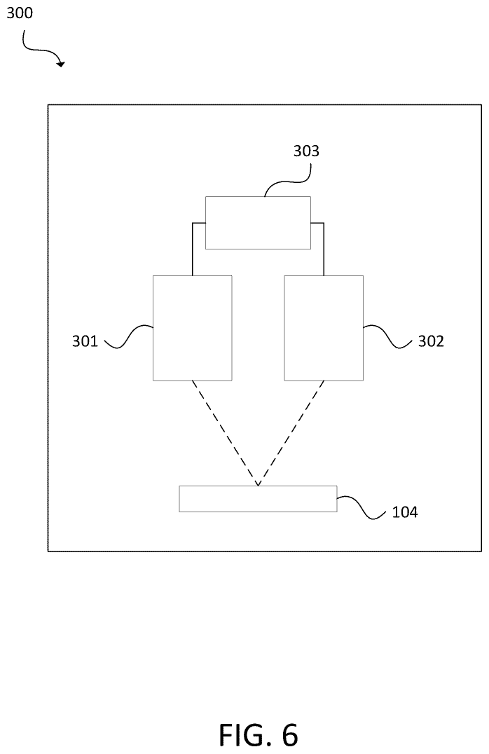

A single tool can provide both MPSE and MWRM measurements for enhancement in sensitivity to strain, composition, and thickness. The system 300 in FIG. 6 includes a MPSE unit 301 to measure a workpiece 104 and generate first optical measurements and a MWRM unit 302 to measure the workpiece 104 and generate second optical measurements. The MPSE unit 301 may correspond to that illustrated in FIG. 4 and the MWRM unit 302 may correspond to that illustrated in FIG. 1. Both the MPSE unit 301 and the MWRM unit 302 are in electronic communication with a processor 303. The processor 303 can be configured to perform various steps of the method 200.

Other measurement technology also can be included in this tool. Embodiments disclosed herein can provide a reference on the same wafer and samples from another metrology, like current methods (TEM, XRD), can be incorporated for further performance enhancement. The tool also can provide traditional Raman alone measurement as well MPSE alone measurement for applications that only need a single measurement (Raman or MPSE). This allows the tool to have multiple applications.

In an embodiment, a single-pass SE and SR can be used in combination with Raman or MWAM. The performance may still provide useful information at development stage for the GAA devices.

Joint measurement of MWRM and MPSE in one tool can provide more sensitivity and correlation breaking in analyses. Sensitivity to strain and composition may be enhanced and correlation between strain/composition and thickness may be reduced. The joint measurement signals can provide enough sensitivity and correlation breaking to extract the strain 3D profiles in fins, nanosheets and silicon waveguides. Correlation breaking of in-plane and out-of-plane strain can be provided for general films, such as SiGe/Si and SiC/Si, SiCP/Si layers, SiGe/Si superlattice in logic device transistor mobility engineering. The combined CD, thickness, composition, and stress measurements also can be used with DRAM and 3D DRAM channels. This can be achieved during signal acquisition by the selection of multiple polarization angles in Raman and angles of incidence (AOIs) in MPSE.

In an embodiment, MWRM and MPSE are integrated into one tool so workpiece handing and measurements are performed at one stop. The two sets of optics and mechanical assemblies are integrated into one tool with shared wafer handling, measurements, and calibrations. In addition, analyses of data to determine the CD, thickness, and stress also use a single unified algorithm and software for optimized measurement performance and operational efficiency. The MWRW and MPSE measurements are still conducted one at a time as two sets of signals, but the signals are input together to the analysis software. The measurement output (results) for the CD, thickness, and stress are a single set of results for target from the workpiece.

Analysis of the combined measurement data can provide synergy to sensitivity and breaks correlation. SE alone has gaps for strain and composition. Raman alone has a gap for individual thickness limiting determination of volume of strained thickness. Use of both MPSE and MWRM avoids these gaps and amplifies the individual MPSE and MWRM strengths.

In an example, a post-SiGe release process undergoes nanosheet surface roughness issues, which can lead to channel mobility degradation and variability. The combined measurement data can enable sheet-specific surface roughness metrology.

Embodiments disclosed herein can provide separation of fully strained versus partially strained film structures. This can enable determination of a volume or interface that is not relaxed or partially strained. Fully strained versus partially strained cannot be determined by a single MWRM or MPSE, but can be distinguished in the joint measurements. The joint measurements allow one to determine not only the stress but also the optical n and k (index of diffraction). For the same stress, fully strained Si or SiGe will have higher n and lower k compared to partially strained. For optimized transistor electrical performance, a fully strained channel is preferred to achieve higher mobility and less variation. So the ability to measure full versus partial strain is important for process and integration.

Embodiments disclosed herein can be applied to FinFET and other FET devices that use stress-mobility engineering during the device fabrication processes. For example, a GAA FET, DRAM, or 3D DRAM device may be measured.

Embodiments disclosed herein can provide accurate, robust, and practical measurement of stress and stressed volume of individual transistor channels in a GAA device during fabrication processes. Stress anisotropy may be monitored quantitatively. Stress and the process properties that create the stress in the channel can be measured in the same location and same measurement, providing feedback for stress tuning and targeting. Measurement of channel stress at multiple process steps that result in the final transistor stress and driving current may allow optimization of processes and process window at each step for more robust and manufacturable fabrication flow. Fast and effective characterization of processes can speed up GAA development. Added sampling for ramp and production troubleshooting also can be provided. Embodiments disclosed herein also can provide immediate and early detection of potential electrical behavior and excursions at the current process steps versus such excursion detection only at final electrical test that are the cumulative results of several process steps.

While other machine learning models are possible, a neural network or deep learning model is used for machine learning in an embodiment. Machine learning can be used with the theoretical models or can be used as a standalone technique if enough reference data is provided.

It will be understood that, while exemplary features of a method have been described, such an arrangement is not to be construed as limiting the disclosure to such features. The method may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, quantum computer, workstation, minicomputer, or mainframe computer. The steps of the method may be implemented by a server or computer in which the software modules reside or partially reside. The computer or computers may be part of a metrology tool or a standalone computer. The computer or computers may be online or offline. The processing requirements for the computer or computers may be based on the tool throughput and time-to-solution targets.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s), i.e. of the control system, may be programmed to perform the functions of an embodiment of the method described herein. The processor(s) is a hardware device for executing software, particularly software stored in memory. Processor(s) can be any custom made or commercially available processor, a primary processing unit (CPU), an auxiliary processor among several processors associated with a computer, a semiconductor-based microprocessor (in the form of a microchip or chip set), a macro-processor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example, the software in memory includes the one or more components of the method and is executable on a suitable operating system (O/S).

The present disclosure may include components provided as a source program executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object-oriented programming language, which has classes of data and methods, or (b) a procedural programming language, which has routines, subroutines, and/or functions, for example but not limited to, C, C++, Pascal, Basic, Fortran, Cobol, Ped, Java, and Ada.

An additional embodiment relates to a non-transitory computer-readable medium storing program instructions executable on a processor for performing a computer-implemented method for determining measurements of a workpiece, as disclosed herein. In particular, a memory may contain non-transitory computer-readable medium that includes program instructions executable on a processor or other computing device. The computer-implemented method may include any step(s) of any method(s) described herein, including an embodiment of the method 200. The steps can include: receiving first optical measurements of a workpiece measured using MPSE; receiving second optical measurements of the workpiece using multi-wavelength Raman spectroscopy; combining the first optical measurements and the second optical measurements to form combined measured data; and determining a stress measurement of the workpiece using the combined measured data. A model and/or a machine learning algorithm can be used for the combining.

A system can be used to perform the measurements and determine a thickness, composition, or other information about a film stack of a workpiece. The system can include a MPSE unit to measure a workpiece and generate first optical measurements and a multi-wavelength Raman spectroscopy unit to measure the workpiece and generate second optical measurements. The system can include multiple independent measurement systems or can be a cluster tool with multiple measurement systems.

A processor is in electronic communication with the MPSE unit and the multi-wavelength Raman spectroscopy unit. The processor is configured to combine the first optical measurements and the second optical measurements to form combined measured data and then determine a stress measurement of the workpiece using the combined measured data. A model and/or a machine learning algorithm can be used to determine the stress measurement.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
measuring a workpiece using multiple-pass spectroscopic ellipsometry (MPSE) thereby generating first optical measurements;
measuring the workpiece using multi-wavelength Raman spectroscopy thereby generating second optical measurements;
combining, using a processor, the first optical measurements and the second optical measurements to form combined measured data; and
determining, using the processor, a stress measurement of the workpiece using the combined measured data.

2. The method of claim 1, further comprising determining, using the processor, a critical dimension of the workpiece using the combined measured data.

3. The method of claim 2, further comprising determining, using the processor, a shape of a feature on the workpiece using the combined measured data.

4. The method of claim 3, further comprising determining, using the processor, electrical parametric performance of a device on the workpiece using the stress measurement, the critical dimension, and the shape of the feature.

5. The method of claim 1, wherein the determining uses a model.

6. The method of claim 1, wherein the determining uses a machine learning algorithm.

7. The method of claim 1, wherein the stress measurement includes a stressed volume and directional components.

8. The method of claim 1, further comprising determining a thickness, a strain, or a composition of the workpiece.

9. The method of claim 1, wherein the stress measurement is of a transistor channel on the workpiece.

10. A system comprising:
a multiple-pass spectroscopic ellipsometry (MPSE) unit to measure a workpiece and generate first optical measurements;
a multi-wavelength Raman spectroscopy unit to measure the workpiece and generate second optical measurements; and
a processor in electronic communication with the MPSE unit and the multi-wavelength Raman spectroscopy unit, wherein the processor is configured to:
combine the first optical measurements and the second optical measurements to form combined measured data; and
determine a stress measurement of the workpiece using the combined measured data.

11. The system of claim 10, wherein the processor is further configured to determine a critical dimension of the workpiece using the combined measured data.

12. The system of claim 11, wherein the processor is further configured to determine a shape of a feature on the workpiece using the combined measured data.

13. The system of claim 12, wherein the processor is further configured to determine electrical parametric performance of a device on the workpiece using the stress measurement, the critical dimension, and the shape of the feature.

14. The system of claim 10, wherein the stress measurement is determined using a model.

15. The system of claim 10, wherein the stress measurement is determined using a machine learning algorithm.

16. The system of claim 10, wherein the stress measurement includes a stressed volume and directional components.

17. The system of claim 10, wherein the processor is further configured to determine a thickness, a strain, and a composition of the workpiece.

18. A non-transitory computer-readable storage medium, comprising one or more programs for executing the following steps on one or more computing devices:
receive first optical measurements of a workpiece measured using multiple-pass spectroscopic ellipsometry (MPSE);
receive second optical measurements of the workpiece using multi-wavelength Raman spectroscopy;
combine the first optical measurements and the second optical measurements to form combined measured data; and
determine a stress measurement of the workpiece using the combined measured data.

19. The non-transitory computer-readable storage medium of claim 18, wherein the stress measurement is determined using a model.

20. The non-transitory computer-readable storage medium of claim 18, wherein the stress measurement is determined using a machine learning algorithm.
